(19) United States
(12) Patent Application Publication
(10) Pub. No.: US 2018/0284452 A1
(43) Pub. Date: Oct. 4, 2018

(54) HEAD-UP DISPLAY FOR A HELMET

(71) Applicant: Nuviz Oy, Salo (FI)

(72) Inventors: Valtteri EROMA, Salo (FI); Petri HIRVONEN, Salo (FI); Ilkka HUSGAFVEL, Salo (FI); Arto KIEMA, Salo (FI); Kimmo KOMPPA, Salo (FI); Tuomo KOSKINEN, Salo (FI); Juha KUUSISTO, Salo (FI); Tero NORDSTROM, Salo (FI); Marko PUTTONEN, Salo (FI); Anssi SAARIKKO, Salo (FI); Janne SALONEN, Salo (FI); Heli SÄDE, Salo (FI); Anssi VIRTA, Salo (FI); Sari WIBERG, Salo (FI)

(21) Appl. No.: 15/938,539

(22) Filed: Mar. 28, 2018

(30) Foreign Application Priority Data
Mar. 29, 2017 (FI) 20175290

(51) Int. Cl. G02B 27/01; G02F 1/1362; G03B 21/00; A42B 3/04

(52) U.S. Cl. CPC G02B 27/0172; G02F 1/1362; G02F 2203/02; A42B 3/042; G03B 21/006

(57) ABSTRACT

A HUD for a helmet having an image projector attached to a body and configured to project images. The HUD has a projection optical combiner configured to produce a transparent display of the images. A holder supports the combiner outside the helmet such that the images are visible to a user of the helmet when the head-up display is in use. A forward facing part of the combiner, such as the entire combiner or its forward facing portion, is user replaceable. A system that has the HUD and a spare user replaceable forward facing part and a system having the HUD and the helmet are additionally disclosed.

### TECHNICAL FIELD

The aspects of the disclosed embodiments generally relate to a helmet head-up display.

### BACKGROUND ART

This section illustrates useful background information without admission of any technique described herein representative of the state of the art.

US2015338659 (A1) discloses a head-up (HUD) display for motorists by Nuviz. As shown in FIG. 1, the HUD display 2 is attachable to a chin bar of a helmet 4 and projects a transparent display image for the user 1 wearing the helmet such that information can be augmented to the real life view that is seen through a visor of the helmet. To this end, the HUD comprises a transparent combiner 8, which combines the display image to the sight overlaying the scene behind the combiner 8 i.e. within the field of view 6 of an eye 5 of the user 1. No cameras are used or needed for observing the scenery and thus a motorist can keep on riding the motorbike without worrying about depletion of batteries or malfunction of a camera that would image the scenery. Moreover, the scenery appears as real as without the HUD because the user 1 sees the scenery through the transparent combiner 8.

The use of augmented reality in a helmet is advantageous for a variety of reasons including the possibility to maintain the eyes focused far ahead, thus removing the eye strain caused by refocusing when ordinary speedometers or other equipment are glanced at by the motorist.

The Nuviz HUD is an add-on accessory configured for surface-mounting with strong adhesive attachment. As such, it enables use of virtually any helmet of the liking of the motorist, but exposed surfaces of the HUD might be accidentally damaged by external objects.

Skully have published augmented reality enabled helmets (AR-1) that contains a built-in HUD display inside the helmet, see http://www.designboom.com/technology/skully-ar1-motorcycle-helmet-08-12-2014/ for example. The built-in HUD contains the optics and electronics inside the helmet which thus protects the optics. However, the helmet must be spacious inside to accommodate the HUD equipment. Moreover, new pieces of hardware are introduced inside the protective shell of the helmet which results in new design challenges for ensuring the primary task of the helmet i.e. crash protection.

US 2010254017 A1 disclosed a head-mounted display with a headband supporting a display device and WO 2014186682 A1 disclosed an HUD equipped helmet. These publications disclosed arrangements in which an augmenting image is formed or reflected right next to the eye of the user.

It is an object of the disclosed embodiments to remove or mitigate aforementioned problems of prior art HUD helmets or to at least provide new technical alternative for existing technology.

### SUMMARY

According to a first example aspect of the disclosed embodiments there is provided a head-up display for a helmet, comprising:

an image projector configured to project images;

a projection optical combiner configured to produce a transparent virtual display of the images; and

a holder configured to support the combiner outside the helmet such that the images are visible to a user of the helmet when the head-up display is in use; wherein

the combiner comprises a user replaceable forward facing part; wherein

the user replaceable forward facing part is the entire combiner or a portion of the combiner including the forward facing surface of the combiner.

Advantageously, the head-up display having a combiner outside the helmet may avoid some helmet design challenges while the user replaceable forward facing part enables the user to remove disturbing visible scratches from sight should the combiner be damaged e.g. through pebbles or other objects raised in the air by traffic.

The user replaceable forward facing part may be replaceable by the user without tools.

The head-up display may further comprise a position adjustment member configured to enable the user to adjust the position of the head-up display with respect to the helmet in X-and Y-directions. The head-up display may further comprise an orientation adjustment member configured to adjust the orientation of the head-up display after attaching of the head-up display to the helmet.

The head-up display may be user attachable to the helmet. The head-up display may be universally attachable to different helmets of different make and model.

Advantageously, the property of the head-up display being attachable enables the user to upgrade the helmet of his/her liking to become head-up display enabled and removes the need to purchase a new helmet and the related waste of raw materials.

The helmet may be a motorbike helmet. The helmet may be a full-face helmet. The helmet may be equipped with a visor. The head-up display may be attachable to such that the visor can be turned up at least partially out of sight of the user and back while maintaining the head-up display in place. The head-up display may be attachable to a chin bar of the helmet.

The head-up display may be adhesively attachable to the helmet. Alternatively or additionally, the head-up display may be attachable to the helmet using any of screws; magnetic attaching; suction attaching; attaching band surrounding the helmet; or any other attaching means.

The head-up display may comprise a body. The body may be configured to attach the head-up display to the helmet The body may be configured to attach the head-up display to the helmet directly or through one or more intermediate parts. The body may be configured to user releasably attach the head-up display to the helmet. The body may be attachable to the helmet with any of screws; an adhesively attached intermediate part such as a latch; a suction cup; and/or glue.

The holder may be attached to the body. The holder may be user releasably attachable to the body. Alternatively or additionally, the holder may be attachable to the helmet. The holder may be user attachable to the helmet.

The body and the holder may share a common structure. The common structure may extend partly or entirely over the body. The common structure may extend partly or entirely over the holder.

The head-up display may comprise a sliding engagement structure configured to enable a user to slide the user replaceable forward facing part into place. The sliding engagement structure may comprise rails. The rails may be friction rails. The friction rails may comprise seals configured to induce desired friction and inhibit entry of dust and moisture into the combiner.

The head-up display may comprise a snap-on attaching structure for maintaining in place the user replaceable forward facing part. The snap-on attaching structure may comprise a latch.

Advantageously, the head-up display may comprise a simple, quick and intuitive mechanism for replacing the user replaceable forward facing part.

The head-up display may comprise a position adjustment member configured to enable the user to adjust positioning of at least the combiner with relation to the helmet.

The head-up display may comprise a orientation adjustment member configured to enable the user to adjust orientation of at least the combiner with relation to the helmet.

The head-up display may be configured to enable attaching to the helmet on a user-selectable position with relation to the centerline.

Advantageously, the user may be allowed to adjust the position and orientation of the head-up display after attaching to the helmet and/or to better adapt the display of images to her liking and/or to adapt the head-up display to the user-selectable position.

The head-up display may be configured to pass images from the image projector via the combiner into the user's eye, creating a virtual image with sufficient viewing distance to reduce eye accommodation stress.

Advantageously, the eye strain may be reduced and also the observing of traffic and scenery may be facilitated by quick and easy transfer of gaze from the virtually displayed image to the scene.

The combiner may be configured to pass the images from the image projector to the user without changing focal plane distance of the virtual image. The optical elements of the combiner may be optically planar at least along an optical path of the images.

Advantageously, the combiner is simple and economical to produce from optically planar parts such that the entire combiner may be inexpensive to replace.

The combiner may comprise a partially reflective transparent mirror configured to reflect light that forms the images while allowing light received from the scene to pass through the combiner thus making the images appear transparent particularly for areas where no image pixels are shown.

The image projector may comprise a spatial light modulator. The image projector may comprise a display. The display may be a miniaturized display. The display may be reflective display. The display may be an active-matrix liquid-crystal display. The image projector may comprise a liquid crystal on silicon unit. Alternatively or additionally, the image projector may comprise a digital light processing unit, such as a digital micro mirror device.

According to a second example aspect of the invention there is provided a system comprising the head-up display and a spare user replaceable forward facing part. The system may comprise multiple user replaceable forward facing parts for replacement by the user on demand.

According to a third example aspect of the invention there is provided a system comprising the head-up display and the helmet. The system may further comprise one or more user replaceable forward facing parts for replacement by the user on demand.

Different non-limiting example aspects and embodiments of the present disclosure have been illustrated in the foregoing. The embodiments in the foregoing are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

Some example embodiments of the present disclosure will be described with reference to the accompanying drawings, in which:

FIG. 1 shows a prior art HUD helmet system;

FIG. 2 shows an HUD helmet system of an example embodiment of the present disclosure;

FIG. 3 shows a detailed view of an embodiment of a combiner shown in FIG. 2; and

FIG. 4 shows a view of some details of an HUD apparatus of an example embodiment of the present disclosure.

### DETAILED DESCRIPTION

In the following description, like reference signs denote like parts.

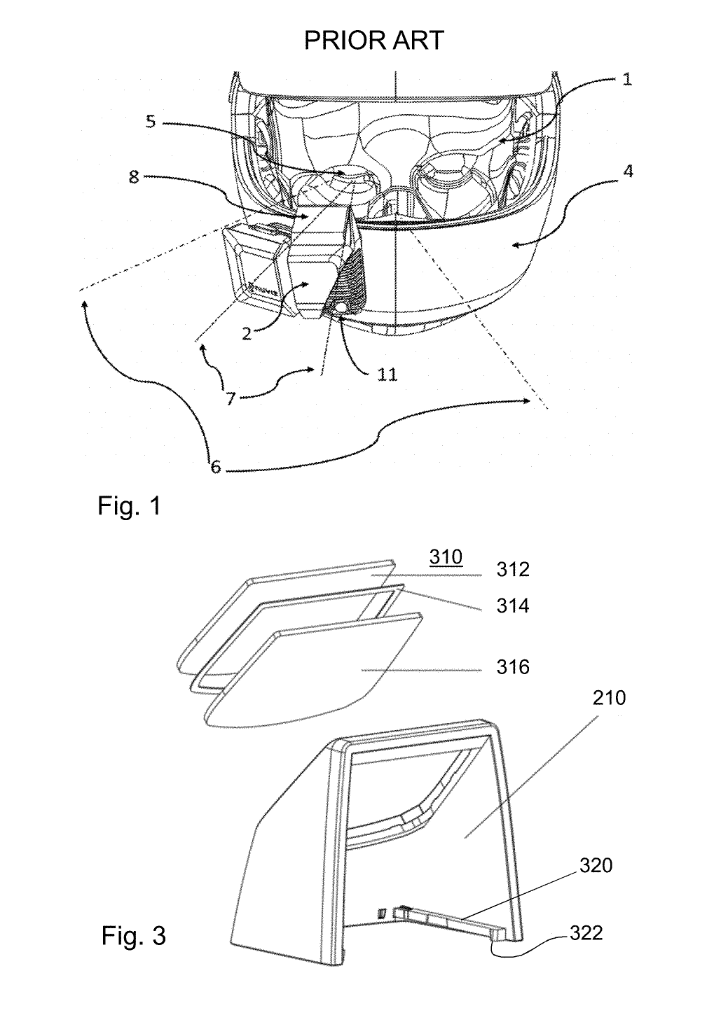

FIG. 1 has been discussed in the background art section.

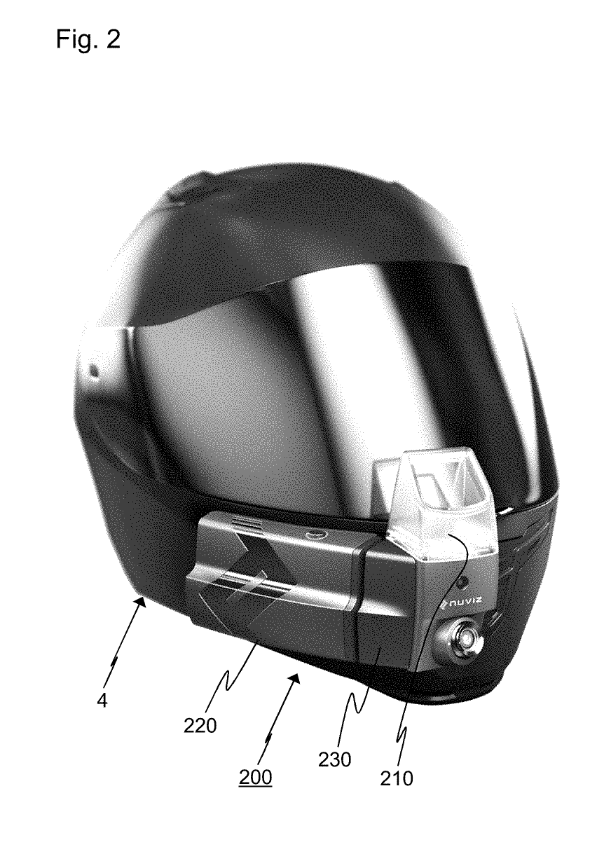

FIG. 2 shows an HUD apparatus 200 of an example embodiment of the present invention and a helmet 4. The HUD apparatus 200 comprises a transparent combiner 210, a body 220 and a holder 230 attached to the body 220 for holding the transparent combiner 210 in place. In this context, the transparent combiner is transparent to an extent that allows perception of scenery through the transparent combiner in at least most of its image projection area by which images produced by the HUD apparatus 200 are reflected to the field of view of the user as with the prior art system shown in FIG. 1. For example, the combiner may pass through at least 40%, 50%, 60%, 70% or 90% of visible light from the scenery ahead of the combiner 210. The HUD apparatus 200 can be releasably attached to the helmet 4 as in the prior art system that is illustrated by FIG. 1.

In FIG. 2, the holder 230 is implemented with a body or frame of the HUD apparatus 200 and extends from an attaching surface to the combiner 210. In other embodiments, the holder 230 can be a discrete part supporting the transparent combiner 210 separately from some other parts of the HUD apparatus 200. In further other embodiments, the holder 230 can be integrated with the body 220 into a single element as will be subsequently described by way of example.

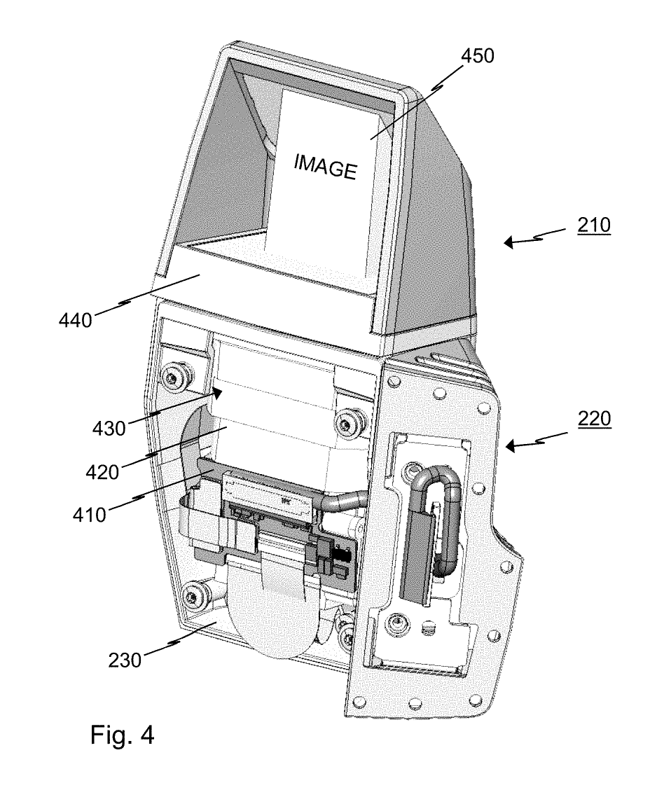

FIG. 3 shows a detailed view of an embodiment of the combiner 210 of FIG. 2. The combiner 210 comprises a transparent mirror 310. The transparent mirror 310 comprises a front plate 312, a separator 314 and a front plate 316. The transparent mirror 310 is configured to receive a projected image from an image beam 450 (FIG. 4) and reflect that e.g. by specular reflection towards the eye of the user.

The transparent mirror 310 is permanently fixed to the combiner 210 in an example embodiment. In such an embodiment, the entire combiner 210 of FIG. 3 is configured to be releasably mountable using rails 320 on both side walls of the combiner (one rail 320 is not shown, but the combiner of FIG. 3 is symmetric so that the concealed side matches that seen in FIG. 3). The rail 320 comprises a notch 322 for engaging with a latch when the combiner 210 is slidden in to a matching mounting base 440 (FIG. 4) of the holder 230 of the HUD apparatus 200.

In an example embodiment, the rails are complemented with seals running between the combiner 210 and the base mounting unit so as to seal the interior against dust and moisture and/or to induce friction so as to avoid unintended detachment of the combiner 210 during use of the HUD apparatus 200 and/or on replacing the combiner 210.

FIG. 4 shows a view of some details of the HUD apparatus 200 of FIGS. 2 and 3, or more accurately a view into the holder 230, the body 220 and the combiner 210. The HUD apparatus 200 comprises, here supported to the holder 230, a display unit 410, a beam splitter such as a polarizing beam splitter cube 420, optics 430 such as one or more lenses configured to form a focal plane for the virtual image at desired distance, the mounting base 440 and an illustration of a beam 450 formed by the projected image.

FIG. 4 is drawn to illustrate the holder, body and combiner as open structures for the sake of better view into the interior of these parts. Alternatively, any one or more of these can be closed with a suitable back wall. A closed structure may avoid entry of moisture and/or dirt or mechanical damage.

The body 220 may be formed of one or more parts. For example, the body 220 may be molded of a single piece of plastics to extend from attaching structures of the HUD apparatus 200 to the holder 230 and/or the mounting base 440 of the combiner 210. For example, a housing for an HUD apparatus of an example embodiment is manufactured of transparent material. In an embodiment, the transparent material forms also a body for the combiner and leaves an external transparent part of the combiner replaceable by the user.

In FIGS. 3 and 4, the transparent mirror 310 is permanently fixed to the combiner 210 and the entire combiner 210 is replaceable. In another example embodiment, only an outmost part of the transparent mirror 310 or only the transparent mirror is replaceable. In this case, the respective part is configured to be releasably attachable by the user. Any clips, rails, snap-on and magnetic attachment implementations known from the art of user releasable attachment can be employed.

The HUD apparatus 200 can be attachable to the helmet 200 releasably as described in US2015338659 A1 paragraphs 39 to 46.

In an example embodiment, the HUD apparatus 200 comprises a position adjustment member configured to enable the user to adjust positioning of at least the combiner with relation to the helmet. The position adjustment member comprises e.g. a screw-adjustment in X and Y-directions of the position of the HUD apparatus 200 with respect to its attaching point on the exterior surface of the helmet.

In an example embodiment, the HUD apparatus 200 comprises an orientation adjustment member configured to enable the user to adjust orientation of at least the combiner with relation to the helmet. The orientation adjustment member comprises, for example, a releasable and lockable ball joint configured to enable the user to adjust orientation or direction of the HUD apparatus 200 or at least of its optics.

In an example embodiment, the HUD apparatus 200 is configured to enable attaching to the helmet on a user-selectable position with relation to the centerline. Hence, the user can mount the HUD apparatus 200 on either left-hand side or right-hand side as desired and also possibly taking into account her eyesight that may significantly differ between the left and right eyes.

Various embodiments have been presented. It should be appreciated that in this document, words comprise, include and contain are each used as open-ended expressions with no intended exclusivity.

The foregoing description has provided by way of non-limiting examples of particular implementations and embodiments of the present disclosure a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed embodiments of this invention may be used to advantage without the corresponding use of other features. As such, the foregoing description shall be considered as merely illustrative of the principles of the present disclosure, and not in limitation thereof. Hence, the scope of the invention is only restricted by the appended patent claims.

1. A head-up display for a helmet, comprising:
an image projector configured to project images;
a projection optical combiner configured to produce a transparent virtual display of the images; and
a holder configured to support the combiner outside the helmet such that the images are visible to a user of the helmet when the head-up display is in use;
the combiner comprises a user replaceable forward facing part;
the user replaceable forward facing part is the entire combiner or a portion of the combiner including forward facing surface of the combiner;
the projection optical combiner comprises a transparent mirror for producing the transparent virtual display of the images; wherein
the combiner comprises two side walls for supporting the transparent mirror; and
the head-up display further comprises a position adjustment member configured to enable the user to adjust the position of the head-up display with respect to the helmet in X-and Y-directions and an orientation adjustment member configured to adjust the orientation of the head-up display after attaching of the head-up display to the helmet.

2. The head-up display for a helmet according to claim 1, wherein the head-up display is user attachable to the helmet.

3. The head-up display for a helmet according to claim 1, wherein the side walls are transparent.

4. The head-up display for a helmet according to claim 2, wherein the side walls are transparent.

5. The head-up display for a helmet according to claim 1, wherein the helmet is a motorbike helmet for which the holder is configured.

6. The head-up display for a helmet according to claim 1, wherein the image projector comprises a reflective display.

7. The head-up display for a helmet according to claim 6, wherein the reflective display comprises a reflective active-matrix liquid-crystal display.

8. The head-up display for a helmet according to claim 1, wherein the image projector comprises a polarizing beam splitter.

9. The head-up display for a helmet according to claim 6, wherein the image projector comprises a polarizing beam splitter.

10. The head-up display for a helmet according to claim 1, wherein the head-up display comprises a sliding engagement structure configured to enable a user to slide into place the user replaceable forward facing part.

11. The head-up display for a helmet according to claim 1, wherein the head-up display comprises any of clips, rails, snap-on and magnetic attachment means for user releasable attachment of the transparent mirror or its outmost part to the combiner.

12. The head-up display for a helmet according to claim 2, wherein the head-up display comprises any of clips, rails, snap-on and magnetic attachment means for user releasable attachment of the transparent mirror or its outmost part to the combiner.

13. The head-up display for a helmet according to claim 1, wherein the helmet for which the head-up display is configured is a full-face motorbike helmet.

14. The head-up display for a helmet according to claim 1, wherein:
the head-up display is configured for a helmet that is equipped with a visor such that the visor can be turned up at least partially out of sight of the user and back while the head-up display is in place.

15. The head-up display for a helmet according to claim 1, wherein the head-up display is attachable to a chin bar of the helmet.

16. The head-up display for a helmet according to claim 13, wherein the head-up display is attachable to a chin bar of the helmet.

17. The head-up display for a helmet according to claim 14, wherein the head-up display is attachable to a chin bar of the helmet.

18. The head-up display for a helmet according to claim 1, wherein the user replaceable forward facing part is replaceable by the user without tools.

19. The head-up display for a helmet according to claim 1, wherein the head-up display is configured to pass images from the image projector via the combiner into the user's eye creating a virtual image with sufficient viewing distance for reducing eye accommodation stress.

20. The head-up display for a helmet according to claim 1, wherein the optical elements of the combiner are optically planar at least along an optical path of the images.
